(19) United States
(12) Patent Application Publication
(10) Pub. No.: US 2006/0221623 A1
(43) Pub. Date: Oct. 5, 2006

(54) Lamp holder

(75) Inventor: Wen Ho Yang, Taipei Hsien (TW)

Correspondence Address: BACON & THOMAS, PLLC, 625 SLATERS LANE, FOURTH FLOOR, ALEXANDRIA, VA, 22314, US

(73) Assignee: Sun Lite Sockets Industry Inc., Taoyuan Hsien (TW)

(21) Appl. No.: 11/098,452

(22) Filed: Apr. 5, 2005

(51) Int. Cl. F21V 19/00

(52) U.S. Cl. 362/382

(57) ABSTRACT

A lamp holder includes a body provided with a recessed room, a metal helical cylinder fitted in the recessed room for a lamp bulb to screw with. The body has a through hole vertically in the body, and an elastic conductive unit is positioned in the through hole. A central conductor is fixed at the bottom side of the body, located at one side of the through hole and connected with one terminal of electricity. The elastic conductive unit consists of a coil spring and a conductive rod fitted around by the coil spring. The conductive rod has its lower end normally separated from the central conductor by the elasticity of the coil spring. Unless a lamp bulb is screwed in the helical cylinder completely, it cannot push down enough the conductive rod to let electricity get through to light up the lamp bulb. Thus the safety of the lamp holder is enhanced.

### BACKGROUND OF THE INVENTION

1. Field of the Invention

This invention relates to a lamp holder, particularly to one especially applicable to a lamp provided with a special sized helical base to screw in the lamp holder to let electricity get through, thus upgrading safety of using the lamp holder.

2. Description of the Prior Art

A lamp holder is used for a lamp bulb to be screwed in to be lit up and to keep the lamp bulb stably in place. A conventional lamp holder shown in FIG. 1 includes a body 10 formed with a recessed room 101 in an upper portion, a metal helical cylinder 102 fitted in the recess room 101 for a lamp bulb 20 to screw with and let a conductor of the lamp bulb contact the helical cylinder 101. Further, a central conductor 104 is fixed at one end on the bottom of the recessed room 101 with a bolt, functioning as another terminal conductor and made of conductive copper or copper alloy, and shaped bent up to locate at the center of the helical cylinder 102. But the central conductor 104 is separated from the helical cylinder for a distance without contacting each other.

In using, when the lamp bulb 20 is screwed with the lamp holder with its helical base 201 fitting with the helical cylinder 102 to contact with each other to get through one terminal of electricity. Then the central contact 202 of the lamp bulb (not connected with the helical base 201) may be pressed to contact the central conductive 104 of the lamp holder so that the body 10 and the lam bulb 20 constitute an electric circuit to get the lamp 20 lit up by electricity.

The conventional lamp holder has been found to have the following disadvantages after making special research about it.

The central conductor 104 of the conventional lamp holder has its free end bent up and having some elasticity to contact the central point 202 and its other end screwed tightly by a bolt 103 and connected with another terminal of electricity. However, the central conductor 104 is always connected to one terminal of electricity, it may be lit up before the helical conductor 201 of the lamp bulb 20 is screwed tightly in the recessed room 101 because of the central conductive point 201 contacting too early conductor 104. Thus a user has to continue screwing the lamp bulb in the lamp holder with the lamp bulb lit up till the lamp bulb 20 is completely tightened stably in the helical cylinder 102 of the lamp holder. Therefore, there is a potent risk existing for a user during the time of screwing manually the lamp bulb 20, say touching electricity. On the one hand, if a user does not know the structure or the way to use the conventional lamp holder, he/she may think the lamp bulb is already screwed properly when the lamp bulb is lit up, stopping screwing the lamp bulb in the lamp holder. Then the lamp bulb 20 may slowly loosen off the lamp holder, and drop down or not be lit up. Moreover, an excessive heat may arise from the worse contact and result in a potent danger. Or adult persons or children who are not familiar with structure of the conventional lamp holder may unwarily touch or tamper with the conductive portions, which would cause some danger.

### SUMMARY OF THE INVENTION

This invention has been devised to offer a lamp holder very safe to use for user, because electricity may not get through unless a lamp bulb is screwed completely in the lamp holder, without possibility of a user getting electrically shocked by toughing conductive portions of the lamp holder.

The lamp holder in the invention includes a body provided with a recessed room in an upper portion for a metal helical cylinder to be fitted therein and functioning as a terminal of electricity. Further, the body is provided a through hole in the center, and an elastic conductive unit is received in the through hole, consisting of a conductive rod and a coil spring. A central conductor is provided at a bottom side of the body, fixed with one terminal of electricity, and located at one side of the through hole. The conductive rod is normally pushed by the elasticity of the coil spring to be separated from the central conductor. When a lamp bulb is screwed in the helical cylinder, the contact point of the lamp bulb pushed down the conductive rod against the elasticity of the coil spring, and unless the lamp bulb is screwed in completely, the conductive rod cannot contact the central conductor to let electricity get through to light up the lamp bulb.

### BRIEF DESCRIPTION OF DRAWINGS

This invention will be better understood by referring to the accompanying drawings, wherein:

FIG. 1 is a side cross-sectional view of a conventional lamp holder and a lamp bulb;

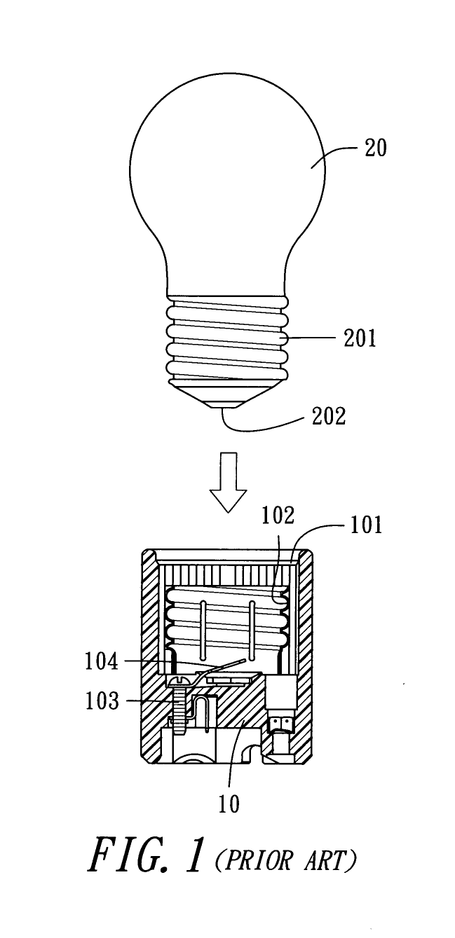

FIG. 2 is a side cross-sectional view of the conventional lamp holder with a lamp bulb screwed therein;

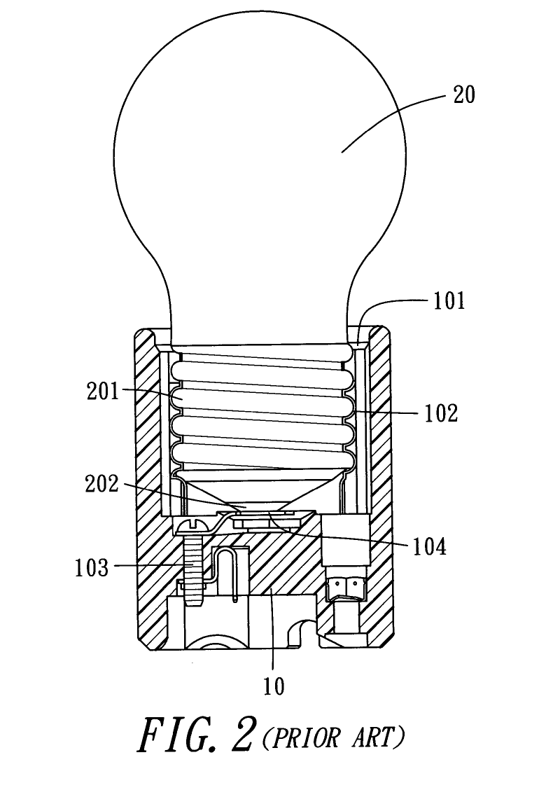

FIG. 3 is an exploded perspective view of a lamp holder in the present invention;

FIG. 4 is an upper view of the lamp holder in the present invention;

FIG. 5 is a side cross-sectional view of the lamp holder and a lamp bulb not yet screwed therein in the present invention;

FIG. 6 is a side cross-sectional view of the lamp holder with a lamp bulb screwed therein in the present invention;

FIG. 7 is a side cross-sectional view of the lamp holder and an incorrect lamp bulb in the present invention; and,

FIG. 8 is a side cross-sectional view of the lamp holder with an incorrect lamp bulb screwed therein in the present invention.

### DETAILED DESCRIPTION OF THE PREFERRED EMBODIMENT

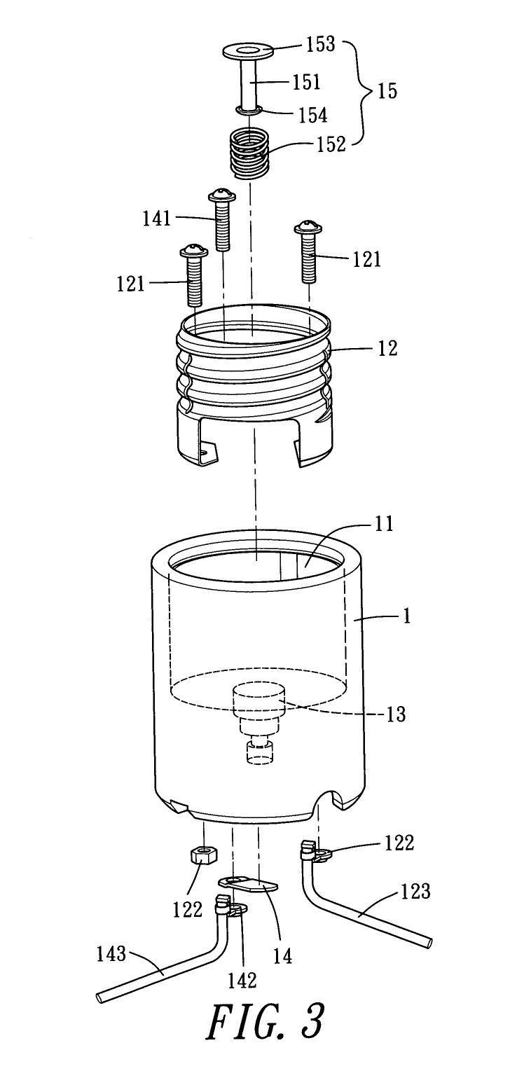

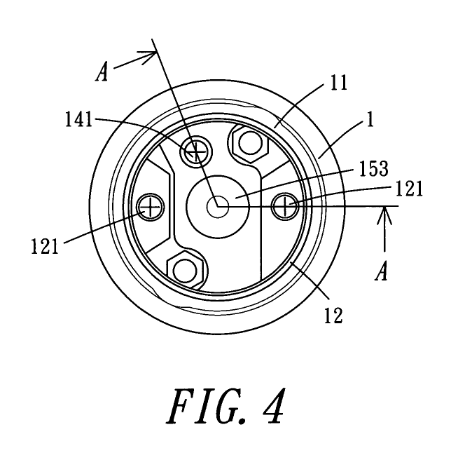

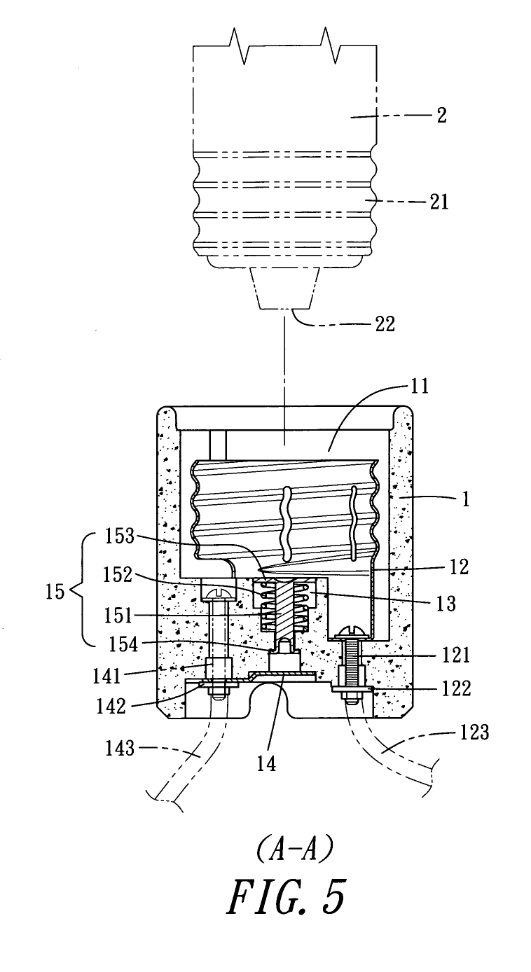

A preferred embodiment of a lamp holder in the present invention, as shown in FIG. 3, includes a body 1, a recessed room 11 formed in an upper portion of the body 1, a metal helical cylinder 12 fitted in the recessed room 11 and secured stably therein with two bolts 121. As shown in FIGS. 4 and 5, the two bolts 121 pass through the bottom of the helical cylinder 12 and the preset holes in the body 1 to screw with nuts 122 at the bottom of the body 1, and one of the nuts 122 is connected with a power cord 123. So the helical cylinder 12 is electrically connected with the power cord 123 to function as one terminal. The body 1 further has a vertical through hole 13 in the center, as shown in FIG. 4, and a central conductor 14 of a plate shape attached at the bottom, having one end provided with a hole for a bolt 141 to pass through from the recessed room 111 to screw with a nut 142, which is connected with a power cord 143, letting the central conductor 14 indirectly connected with the power cord 143 to function as one terminal of electricity. The central conductor 14 is located at one side of the through hole 13, as it is secured by the bolt 141 and the nut 142. Further, an elastic conducting unit 15 consisting of a conductive rod 151 and a coil spring 152 is received in the through hole 13. The conductive rod 151 has a disc 153 at the upper end for an upper end of the coil spring 152 to elastically push against, and the other end provided with a flange 154 reaching almost bottom end of the through hole 13, and the coil spring 152 has its other end resting on the stepped surface a little above the lower end of the through hole 13. Thus, the coil spring 152 is located in the wider portion of the through hole 13, and the conductive rod 151 is normally pushed up by the coil spring 152 to extend in a large portion of the though hole 13 so that there remains enough space for the flange 154 to up and down. The through hole 13 should have several stages of different diameters so that the coil spring 152 may push up the conductive rod 151 to have its lower end or the flange 154 normally separated from the central conductor 14 to cut off electricity. And the conductive rod 151 plus the upper disc 153 and the lower flange 154 should have the whole length shorter than the whole length of the through hole 13 so that the conductive rod 151 may not touch the central conductor 14 to let electricity get through unless the lamp bulb 2 is completely screwed in down, with the lower conductive point 22 of the lamp bulb 2 pushing down the conductive rod 151 enough.

Next, as shown in FIGS. 4 and 5, when the lamp bulb 2 is not yet screwed in the lamp holder, even if a user accidentally touches the helical cylinder 12 or the upper disc 153 of the conductive rod 151, there may not arise any danger to the user of being shocked by electricity, upgrading largely safety in using the lamp holder.

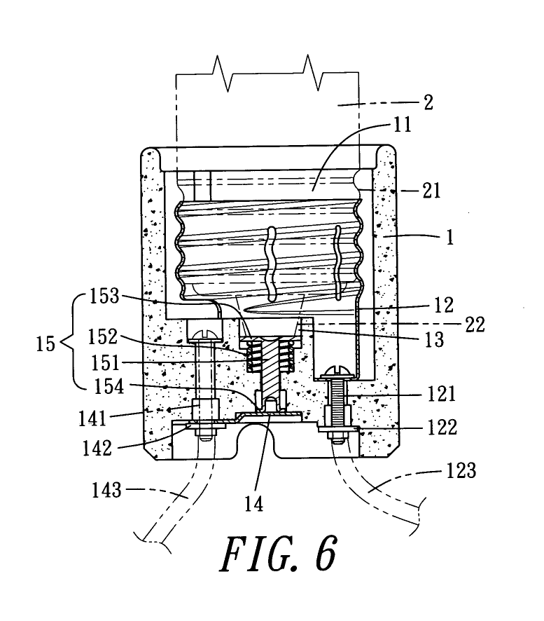

Then as shown in FIG. 6, when the lam bulb 2 is screwed down in the helical cylinder 12 resisting the elasticity of the coil spring 152, the contact point 21 of the lamp bulb 2 completely contacts and pushes the upper disc 153 of the conductive rod 151 until the lower flange 154 contacts tensely the central conductor 14. At this time, electricity may get through to light up the lamp bulb 2.

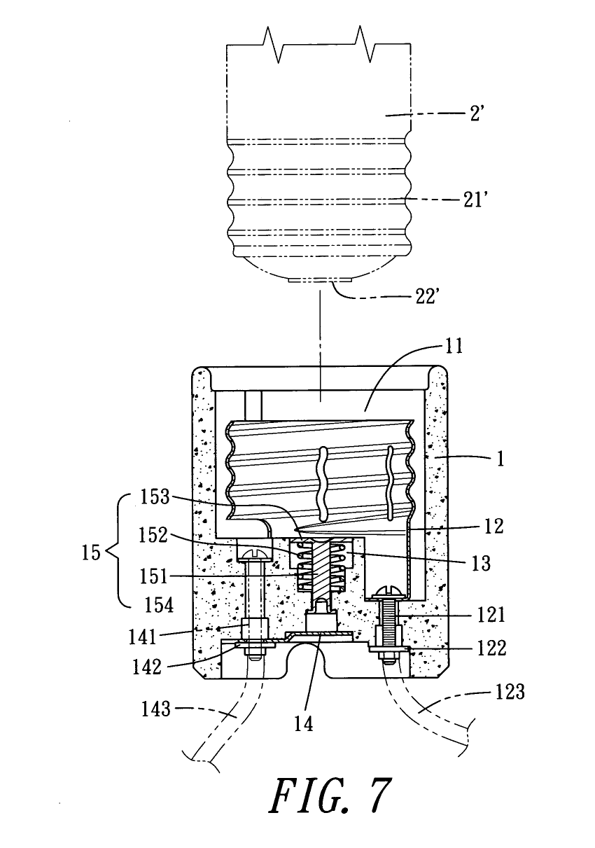

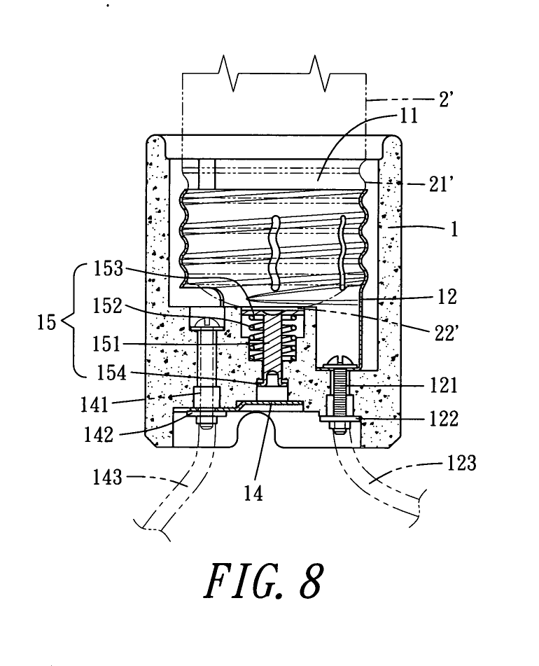

Moreover, as shown in FIGS. 7 and 8, if an incorrect lamp bulb 2′ is used to be screwed in the helical cylinder 12, and the contact point 22′ does not project out for certain height, the lamp bulb 2′ cannot push the upper disc 153 of the conductive rod 151 down to let the lower flange 154 touch the central conductor 14. Then electricity cannot get through. Thus it is clear that a correct special lamp bulb should be used, and the lamp holder in the invention is quite safe to use.

As a important point of the invention, the lamp holder according to the invention makes use of the function of the elastic conductive unit 15 placed in the through hole 13 and consisting of the conductive rod 151 with the upper disc 153 and the lower flange 154 and the coil spring 152 for normally cutting off electricity, and only using the correct lamp bulb 2 can let electricity get through, making the lamp holder very safe to use.

While the preferred embodiment of the invention has been described above, it will be recognized and understood that various modifications may be made therein and the appended claims are intended to cover all such modifications that may fall within the spirit and scope of the invention.

What is claimed is:

1. A lamp holder comprising:
A body provided with a recessed room in its upper portion and a central through hole in the lower portion under said upper portion;
A helical cylinder fixed in said recessed room of said body for a lamp bulb to screw with, said helical cylinder functioning as one terminal;
An elastic conductive unit received in said through hole of said body and consisting of a conductive rod and a coil spring, said coil spring fitting around said conductive rod and pushing against upper end of said conductive rod to keep a lower end of said conductive rod separated from a central conductor;
Said central conductor being of a plate shape and provided at a bottom side of said body, said central conductor fixed at one side of a lower end of said through hole of said body, said central conductor having its outer end fixed with said body and connected with one terminal of power;
Said conductive rod of said elastic conductive unit normally separated from said central conductor when a lamp bulb is not completely screwed in said helical cylinder of said lamp holder, a contact point of said lamp bulb moved down to contact and push down said conductive rod against the elasticity of said coil spring and finally contact said central conductor to let electricity get through when said lamp bulb is screwed deeply enough in said helical cylinder of said body.

2. The lamp holder as claimed in claim 1, wherein said conductive rod has a disc at its upper end for an upper end of said coil spring to elastically push against, said coil spring has its lower end supported by a stepped surface formed a little above the lower end of said through hole of said body, said conductive rod has a flange formed at the lower end, and the whole length of said conductive rod plus said disc and said flange is shorter than the length of said through hole of said body.
